(19) United States
(12) Patent Application Publication
(10) Pub. No.: US 2008/0241436 A1
(43) Pub. Date: Oct. 2, 2008

(54) INKJET RECORDING MEDIUM

(75) Inventor: Masamichi KOBAYASHI, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/052,412

(22) Filed: Mar. 20, 2008

(30) Foreign Application Priority Data
Mar. 29, 2007 (JP) 2007-089676

(51) Int. Cl. B41M 5/50

(52) U.S. Cl. 428/32.22

(57) ABSTRACT

An inkjet recording medium including a water-resistant support, and on the water-resistant support, two or more ink receiving layers including an upper ink receiving layer and a lower ink receiving layer, each of the two or more ink receiving layers containing a pseudo boehmite alumina hydrate, wherein the upper ink receiving layer further contains a polyvinyl alcohol having a saponification degree of 90% or higher and at least one crosslinking agent selected from the group consisting of boric acid and boric acid salts, and the lower ink receiving layer further contains a polyvinyl alcohol having a saponification degree of less than 90% and at least one cross-linking agent selected from the group consisting of boric acid and boric acid salts.

### CROSS-REFERENCE TO RELATED APPLICATION

This application claims priority under 35 USC 119 from Japanese Patent Application No. 2007-089676, the disclosure of which is incorporated by reference herein.

### BACKGROUND OF THE INVENTION

1. Field of the Invention

This invention relates to an inkjet recording medium with an extremely high printing density that can be suitably used for preventing bronzing.

2. Description of the Related Art

Recently, various information processing systems have been developed along with rapid development in the Information Technology (IT) industry, and recording methods and recording devices suitable for respective information processing systems have also been developed and practically used. Among these, an inkjet recording method has been broadly used because it has such advantages that images are recordable on various kinds of recording materials, hard wares (devices) for the inkjet recording method can be manufactured at a comparatively low cost and made compact as well, excellent stillness can be provided, and the like. The latest inkjet recording method can provide so-called “picture like” high quality images.

It is generally required that the recording materials for inkjet recording have properties such as (1) quick drying (high ink absorption speed), (2) ink dots having proper and uniform diameters (no bleeding), (3) excellent granularity, (4) high circularity of dots, (5) high color density, (6) high color saturation (no dullness), (7) excellent water proof, light fastness, and ozone proof at an imaging area, (8) high degree of whiteness, (9) excellent storability of a recording medium (no occurrence of yellow discoloration or image bleeding during long term storage), (10) low deformability and excellent dimensional stability (low curling properties), and (11) excellent running properties in hardware.

In view of the aforementioned facts, in recent years, a recording material having an ink receiving layer with a porous structure has been put into practical use. In this case, excellent quick-dry properties and high glossiness can be obtained. However, higher quality recording images always tend to be required, and requirements for color density and color tone of images are quite severe. For instance, it is important that the color of the high density area is dark in terms of image contrast or distinct gradation, and that bronzing does not occur in terms of color tone or color saturation.

Relating to the above-description, there is a disclosure of an inkjet recording material comprising a support, and two or more ink receiving layers disposed thereon, wherein an ink receiving layer (A) that is nearer to the support contains fumed silica and polyvinyl alcohol having a saponification degree of from 75 to 95%, and an ink receiving layer (B) that is farther from the support contains alumina or alumina hydrates and polyvinyl alcohol having a saponification degree of from 95 to 100% (see Japanese Patent Application (JP-A) Laid-Open No. 2004-223992). This document describes that the inkjet recording material has high glossiness and exhibits excellent ink absorbability and sufficient printing density.

In the inkjet recording material comprising the ink receiving layers (A) and (B), since PVA having a high saponification degree is used for the upper ink receiving layer, bronzing inhibiting effects can be obtained. However, since the fumed silica is used for the lower ink receiving layer, a large amount of binders should be used in order to prevent cracking of the layer. As a result, after printing with a water-based dye ink, the image receiving layer often becomes muddy. Therefore, in the case of a water-based dye ink having a tendency to deeply permeate into the ink receiving layer, it is difficult to obtain an extremely high printing density that is possible with an ink receiving layer containing only pseudo boehmite.

### SUMMARY OF THE INVENTION

According to an aspect of the invention, there is provided an inkjet recording medium comprising a water-resistant support, and on the water-resistant support, two or more ink receiving layers including an upper ink receiving layer and a lower ink receiving layer, the upper ink receiving layer being farther from the water-resistant support than the lower ink receiving layer, the lower ink receiving layer being nearer to the water resistant support than the upper ink receiving layer, and each of the two or more ink receiving layers containing a pseudo boehmite alumina hydrate, wherein the upper ink receiving layer further contains a polyvinyl alcohol (B1) having a saponification degree of 90% or higher and at least one crosslinking agent selected from the group consisting of boric acid and boric acid salts, and the lower ink receiving layer further contains a polyvinyl alcohol (B2) having a saponification degree of less than 90% and at least one cross-linking agent selected from the group consisting of boric acid and boric acid salts.

### DETAILED DESCRIPTION OF THE INVENTION

Hereinafter, exemplary embodiments of the inkjet recording medium of the invention are described in detail.

An inkjet recording medium of the invention comprises a water-resistant support (hereinafter, referred to as a support in some cases), and on the water-resistant support, two or more ink receiving layers including an upper ink receiving layer and a lower ink receiving layer, the upper ink receiving layer being farther from the water-resistant support than the lower ink receiving layer, the lower ink receiving layer being nearer to the water resistant support than the upper ink receiving layer, and each of the two or more ink receiving layers containing a pseudo boehmite alumina hydrate, wherein

the upper ink receiving layer further contains a polyvinyl alcohol (B1) having a saponification degree of 90% or higher (hereinafter, referred to as a “highly saponified PVA” in some cases) and at least one crosslinking agent selected from the group consisting of boric acid and boric acid salts, and

the lower ink receiving layer further contains a polyvinyl alcohol (B2) having a saponification degree of less than 90% (hereinafter, referred to as a “low-saponified PVA” in some cases) and at least one cross-linking agent selected from the group consisting of boric acid and boric acid salts.

In the present invention, ink receiving layers are formed by a pseudo boehmite alumina hydrate. Since the ink receiving layers have a multilayer structure to separate the layer functions, the image receiving layers can have a pore diameter distribution along a thickness direction. Further, in two layers for constituting a multilayer structure, use of a PVA having a high saponification degree in the upper ink receiving layer can prevent bronzing, and use of a PVA having a low saponification degree in the lower ink receiving layer can lower the haze after an ink solvent permeates into the ink receiving layer (after an image is recorded). Accordingly, transparency can be maintained.

The reason why bronzing is prevented when a PVA having a high saponification degree is used in the upper ink receiving layer is not yet clarified. When using a PVA having a high saponification degree, a pseudo boehmite alumina hydrate can easily gel by hydrogen bonding, a pore diameter thereof becomes large, an ink absorption rate becomes large, adsorption to an alumina surface becomes easy, and dye aggregation at the alumina surface is prevented. This may be because bronzing is prevented.

Owing to the aforementioned facts, images having extraordinarily high density may be obtained, and bronzing of the recorded images may be effectively prevented.

The term, “bronzing” is a phenomenon in which the applied ink becomes solid on the surface of the ink receiving layer rather than permeating into the ink receiving layer, and the recorded image is seen bronze-colored (reddish-colored especially at the cyan imaged area).

When the ink receiving layers of the invention have a two layer-structure, one layer at a support side is a lower ink receiving layer, while the other layer that is farther from the support than the lower ink receiving layer is an upper ink receiving layer. Further, when the ink receiving layers include three or more ink receiving layers, among any two layers selected from the three or more ink receiving layers, one layer that is positioned nearer to the support is a lower ink receiving layer, and the other layer that is positioned farther from the support than the lower ink receiving layer is an upper ink receiving layer.

Further, the uppermost layer in the present invention refers to the upper ink receiving layer that is farther from the support when the ink receiving layers are two layers, while it refers to a layer that is furthest from the support in the ink receiving layers when the ink receiving layers are three or more layers.

The inkjet recording medium of the invention includes a water-resistant support, and on the water-resistant support, two or three or more ink receiving layers, and optionally further includes another layer.

When the ink receiving layers in the invention are two layers, the lower ink receiving layer at the support side contains at least a pseudo boehmite alumina hydrate, low-saponified PVA, and boric acid and/or a boric acid salt, and the upper ink receiving layer contains at least a pseudo boehmite alumina hydrate, highly saponified PVA, and boric acid and/or a boric acid salt. Both layers can optionally further contain other components such as inorganic fine particles other than a pseudo boehmite alumina hydrate, PVAs other than those mentioned above, other binders or crosslinking agents, or mordants.

When the ink receiving layers in the invention are three or more layers, among two layers selected from the three or more ink receiving layers, the lower ink receiving layer contains at least a pseudo boehmite alumina hydrate, low-saponified PVA, and boric acid and/or a boric acid salt, and the upper ink receiving layer contains at least a pseudo boehmite alumina hydrate, highly saponified PVA, and boric acid and/or a boric acid salt. Ink receiving layers other than the above two ink receiving layers may have any layer structure, and preferably contain inorganic particles (preferably a pseudo boehmite alumina hydrate), a binder (preferably a PVA), and a cross-linking agent (preferably boric acid or a boric acid salt). The upper and lower ink receiving layers optionally further contain other components such as other PVAs, binders, cross-linking agents, mordants and the like.

The two or more ink receiving layers including the upper and lower ink receiving layers, which are ink receiving layers in the invention, mainly contain inorganic fine particles mainly formed of a pseudo boehmite alumina hydrate. At this point, the description of “mainly containing inorganic fine particles” means that the content thereof with respect to the total solid content for constituting the ink receiving layer is 50 mass % or more, preferably 60 mass % or more, and particularly preferably 65 mass % or more.

Hereinafter, each component for constituting the ink receiving layers will be explained.

### —Pseudo Boehmite Alumina Hydrate—

In the inkjet recording medium of the present invention, the two or more ink receiving layers contain at least one pseudo boehmite alumina hydrate. The two or more ink receiving layers for forming a multilayer is constituted by using an alumina hydrate, whereby the amount of a binder can be greatly reduced as compared to the case in which fumed silica or the like is used, transparency after the ink absorption is greatly improved, and an image having an overwhelmingly high density can be recorded. Further, ink absorbability and ink absorption speed can be improved.

The pseudo boehmite alumina hydrate in the present invention is typically represented by the formula Al₂O₃.nH₂O (1<n<3), and refers to the alumina hydrate when n is larger than 1 but less than 3.

In order to improve the ink absorption speed of the ink receiving layer, the average pore radius of the alumina hydrate is preferably within a range of 1 to 10 nm, and particularly preferably within a range of 2 to 7 nm. If the average pore radius falls within the aforementioned ranges, ink absorbability and fixation of dyes in ink are excellent and occurrences of image bleeding can be prevented.

In order to improve the ink absorption volume of the ink receiving layer, the pore volume of the alumina hydrate is preferably within a range of 0.1 to 0.8 ml/g, and particularly preferably within a range of 0.4 to 0.6 ml/g. If the pore volume falls within the aforementioned ranges, occurrences of cracking and powder falling at the ink receiving layer can be prevented, and the ink receiving layer can exhibit excellent ink absorbability. Further, when the pore radius is within a range of 2 to 10 nm, the pore volume is desirably 0.1 ml/g or larger. If the pore volume falls within the aforementioned range, the ink receiving layer can exhibit excellent ink dye adsorption. Further, a solvent absorbing amount per a unit area of the ink receiving layers is preferably 5 ml/m² or larger, and particularly preferably 10 ml/m² or larger. If the solvent absorbing amount falls within the aforementioned ranges, an overflow of ink particularly when a multicolor printing is performed can be prevented.

In order for the alumina hydrate to absorb a dye in ink and fix the dye satisfactorily, a BET specific surface area of the alumina hydrate is preferably within a range of 70 to 300 m²/g. If the BET specific surface area falls within the aforementioned range, the alumina hydrate can be dispersed sufficiently, a fixation efficiency of a dye in ink can be improved without a deviation of a pore diameter distribution, and image bleeding can be prevented.

In order to increase the concentration of a alumina hydrate dispersion liquid, the number of surface hydroxyl groups of the alumina hydrate is preferably 10²⁰/g or larger. If the number of the surface hydroxyl groups is small, aggregation of the alumina hydrate may readily take place thus making it difficult to increase the concentration of the dispersion liquid.

Various kinds of acids are ordinarily added to the dispersion liquid to stabilize the alumina hydrate dispersion liquid. Examples of such acids include: nitric acid, hydrochloric acid, hydrobromic acid, acetic acid, formic acid, ferric chloride, aluminum chloride and the like: however, the present invention is not limited thereto.

The alumina hydrate may be produced by an already known method, such as hydrolysis of aluminum alkoxides such as aluminum isopropoxide, neutralization of an aluminum salt by alkali, and hydrolysis of aluminate salts. Further, the particle diameter, the pore radius, the pore volume, the specific surface area, and the number of the surface hydroxyl groups of the alumina hydrate can be controlled by adjusting a precipitation temperature, a maturing time, a pH of a solution, a concentration of the solution, coexistent salts and the like.

Methods of hydrolyzing aluminum alkoxide are disclosed in JP-A Nos. 57-88074, 62-56321, 4-275917, 6-64918, 7-10535, and 7-267633, and U.S. Pat. No. 2,656,321, Am. Ceramic Soc. Bull., 54, 289 (1975) and the like. Examples of the aluminum alkoxides include isopropoxide, propoxide, 2-butoxide and the like. With the method, an alumina hydrate having extremely high purity can be obtained.

Other examples of a method of obtaining an alumina hydrate include methods disclosed in JP-A Nos. 54-116398, 55-23034, 55-27824, and 56-120508 in which inorganic salts of aluminum or their hydrates are used as a starting material. Examples of the inorganic salts include: inorganic salts such as aluminum chloride, aluminum nitrate, aluminum sulfate, poly aluminum chloride, ammonium alum, sodium aluminate, potassium aluminate, and aluminum hydroxide, and hydrates thereof.

More specifically, the alumina hydrate can be prepared by a neutralization reaction of an aqueous acidic aluminum salt solution such as aluminum sulfate, aluminum nitrate or aluminum chloride, and an aqueous basic solution such as sodium aluminate, sodium hydroxide or aqueous ammonia. In this case, generally, the aqueous acidic aluminum salt solution and the basic solution are mixed with each other to the extent that the amount of the alumina hydrate to be produced in the solution does not exceed 5 mass %, and reacted with each other under the conditions that pH is adjusted to the range of 6 to 10, and the temperature is kept at 20 to 100° C. Further, an alumina hydrate can be produced by a method disclosed in JP-A No. 56-120508 in which crystals of the alumina hydrate are grown by changing pH alternately at an acid side and at a base side, by a method disclosed in Japanese Patent Application Publication (JP-B) No. 4-33728 in which an alumina hydrate obtained from the inorganic salt of aluminum and alumina obtained by a Beyer method are mixed with each other to thereby rehydrate alumina, and the like.

An average particle diameter of primary particles (average primary particle diameter) of the alumina hydrate is preferably within a range of 5 to 50 nm. In order to obtain higher glossiness, use of plate- or bar-shaped particle whose average primary particle diameter is 5 to 20 nm and whose average aspect ratio (ratio of average particle diameter to average thickness) is 2 or more is preferable.

As the average primary particle diameter of the alumina hydrate, a nominal value of a commercial product maker can be used.

When an average primary particle diameter is measured on the basis of the produced recording medium, it can be determined by taking out the ink receiving layer by cutting, removing a resin component by heated water, collecting only particles by centrifugation, followed by observing the obtained particles by using TEM (transmission electron microscope). At this point, a similar treatment is conducted on a sample as a reference sample which is prepared by applying only an ink receiving layer coating liquid, and the resultant measured value (average value) is compared to the known particle diameter (nm) of the particle of the alumina hydrate used. On the basis of the difference obtained from the comparison, the measurement value (average value) in the recording medium produced is proportionally calculated and converted, whereby the average primary particle diameter in the recording medium produced can be determined. Further, in order to determine the average primary particle diameter, about 100 to 3000 particles are required for the measurement.

The content of the pseudo boehmite alumina hydrate in the ink receiving layer is preferably within a range of 60 to 95 mass %, and more preferably within a range of 70 to 90 mass %. If the content of the pseudo boehmite alumina hydrate falls within the aforementioned ranges, transparency of the ink receiving layer and extremely high image density can obtain, while effectively preventing image bronzing.

### —Polyvinyl Alcohol—

### (1) Highly Saponified PVA

The upper ink receiving layer of the two ink receiving layers included in the inkjet recording medium contains a pseudo boehmite alumina hydrate, and at least one polyvinyl alcohol having a saponification degree of 90% or higher (highly saponified PVA). By containing the highly saponified PVA in the upper ink receiving layer of the two or more ink receiving layers, it is possible to prevent occurrences of bronzing, and to improve scratch resistance on the surface thereof.

If the saponification degree of the highly saponified PVA contained in the upper ink receiving layer is less than 90%, bronzing and scratching may often take place, and coating film strength is weakened, whereby cracking may often take place.

In order to reduce bronzing and improve scratch resistance, and suppress a reactivity of the highly saponified PVA with the alumina hydrate for preventing a coating liquid from gelling during a preparation thereof, a saponification degree of the highly saponified PVA is preferably within a range of 90 to less than 100%, and in order to reduce bronzing and improving scratch resistance, more preferably within a range of 95 to less than 100%.

In the present invention, a saponification degree may be obtained by reacting a remaining acetic acid group in PVA with an already known amount of sodium hydroxide, and by determining a saponification ratio in PVA on the basis of the consumed amount of the sodium hydroxide.

In order to easily produce a porous film, an average polymerization degree of the highly saponified PVA is preferably within a range of 500 to 5000, and more preferably within a range of 1500 to 4500, and in order to obtain a higher density, it is particularly preferably 3000 to 4500. A molecular weight may be determined by a product of the average polymerization degree and a formula weight (molecular weight) of a monomer.

In order to prevent bronzing, a mass ratio (A/B1) of pseudo boehmite alumina hydrate (A) to polyvinyl alcohol (B1; highly saponified PVA) is preferably 8 or less, and more preferably within a range of 4 to 7. If the ratio of A/B1 is 7 or less, since the ratio of the highly saponified PVA to the pseudo boehmite alumina hydrate can be made larger, occurrences of bronzing can be effectively prevented, while maintaining transparency and image density. Further, by adjusting the ratio A/B1 to 4 or larger, bronzing can be reduced, high image density can be obtained, and scratch resistance and percentage of void (i.e., ink absorbability) can be improved.

The content of the highly saponified PVA in the ink receiving layer is preferably within a range of 8 to 25 mass %, and more preferably within a range of 10 to 20 mass %. If the content of the highly saponified PVA falls within the aforementioned ranges, excellent film formability can be obtained and cracking and powder falling can be prevented, while maintaining transparency thereof and effectively preventing image bronzing.

### (2) Low-Saponified PVA

The lower ink receiving layer of the two ink receiving layers included in the inkjet recording medium contains a pseudo boehmite alumina hydrate, and at least one polyvinyl alcohol having a saponification degree of less than 90% (low-saponified PVA). By containing the low-saponified PVA in the lower ink receiving layer of the two or more ink receiving layers, it is possible to improve the transparency of the layer and further to improve the transparency of the ink receiving layer after recording with a dye ink, whereby the image density may be extremely improved.

If the saponification degree of the low-saponified PVA contained in the lower ink receiving layer is 90% or higher, haze after the permeation of an ink solvent to the layer (image recording) tends to deteriorate, and density improving effects resulting from the use of alumina hydrate in the ink receiving layer are impaired, thus making it difficult to obtain high image density.

In order to improve transparency and percentage of void (i.e., ink absorbability) and to obtain higher image density, a saponification degree of the low saponified PVA is preferably within a range of 75 to less than 90%, and more preferably within a range of 85 to less than 90%.

In order to suppress haze deterioration after an ink solvent is absorbed, an average polymerization degree of the low-saponified PVA is preferably within a range of 2000 to 8000, more preferably within a range of 2500 to 6000, and to obtain higher density, particularly preferably within a range of 3000 to 5000. A molecular weight can be determined from a product of an average polymerization degree and a formula weight (molecular weight) of a monomer.

A mass ratio (A/B2) of pseudo boehmite alumina hydrate (A) to a polyvinyl alcohol (B2; a low-saponified PVA) is preferably 10 or higher, and more preferably within a range of 10 to 15. If the ratio A/B2 is 10 or more, the ratio of the pseudo boehmite alumina hydrate to the PVA in the ink receiving layer becomes larger. Therefore, a lower ink receiving layer having excellent transparency can be obtained, extremely high image density can be obtained, and scratch resistance and percentage of void (i.e., ink absorbability) can be improved.

The content of the low-saponified PVA in the ink receiving layer is preferably within a range of 5 to 10 mass %, and more preferably within a range of 6 to 8 mass %. If the content of the low-saponified PVA falls within the aforementioned ranges, an ink receiving layer having excellent transparency whose haze is small after ink solvent permeation can be obtained, thereby obtaining high image density.

The upper ink receiving layer and the lower ink receiving layer in the present invention can contain other binders that will be described later than the polyvinyl alcohols (PVA) described above. Further, when additional ink receiving layers other than the upper ink receiving layer and the lower ink receiving layer are further provided, the additional ink receiving layers can contain components selected from polyvinyl alcohols (PVA) described above and other binders described below.

### —Crosslinking Agent—

Both the upper ink receiving layer and the lower ink receiving layer contain at least one selected from the group consisting of boric acid and a boric acid salt, as a crosslinking agent. By containing the crosslinking agent, the highly saponified PVA, the low-saponified PVA, and an optional binder are crosslinked and hardened. Accordingly, film strength of the ink receiving layers constituted by using a pseudo boehmite alumina hydrate can be improved.

If three or more ink receiving layers including additional ink receiving layers in addition to the upper ink receiving layer and the lower ink receiving layer are provided, the additional ink receiving layers may contain the polyvinylalcohols (PVAs) described above and/or other binders, and cross-linking agents. In this case, the additional ink receiving layers may contain any crosslinking agent. However, in the present invention, boric acid and a boric acid salt is preferably used.

The content of the crosslinking agent in a single layer (each layer such as the upper ink receiving layer, the lower ink receiving layer or the uppermost ink receiving layer provided on the support) is preferably within a range of 0.1 to 40 mass % and more preferably within a range of 0.5 to 30 mass % with respect to the total amount of the polyvinyl alcohols and the other binders. If the content of the crosslinking agent falls within the aforementioned ranges, occurrences of cracking when coating and drying can be prevented.

### —Cationic Polymer—

In the ink receiving layers for constituting the inkjet recording medium, the uppermost layer that is provided farthest from a water-resistant support may contain at least one quaternary ammonium salt type cationic polymer. By selecting and containing a cationic polymer having appropriate polarity, bronzing can be further prevented.

In addition, the uppermost layer preferably contains the aforementioned pseudo boehmite alumina hydrate, a PVA, and a crosslinking agent, in addition to the quaternary ammonium salt type cationic polymer.

Examples of the quaternary ammonium salt type cationic polymers include: polydiallyl dimethyl ammonium chloride, diallyl dimethyl ammonium chloride derivatives, a quaternary ammonium salt type cationic polymer containing a polyurethane skeleton, a quaternary ammonium salt type cationic polymer containing an acryl ester or acryl ester derivative skeleton; and the like.

Among these, polydiallyl dimethyl ammonium chloride and diallyl dimethyl ammonium chloride derivatives are preferable.

A molecular weight of the quaternary ammonium salt type cationic polymer is preferably within a range of 1000 to 50000, and more preferably within a range of 2000 to 30000. A molecular weight within the aforementioned ranges is preferable because stability of the coating liquid may be obtained.

In order to effectively prevent bronzing, the content of the quaternary ammonium salt type cationic polymer in the uppermost layer, with respect to that of the pseudo boehmite alumina hydrate, is preferably within a range of 0.5 to 6 mass %, and more preferably within a range of 1 to 3 mass %. If the content of the quaternary ammonium salt type cationic polymer falls within the aforementioned ranges, occurrences of bronzing on the image (in particular, black color image) that is recorded on the ink receiving layer in which a pseudo boehmite alumina hydrate is used can be prevented. Accordingly, an image having excellent color hue can be obtained.

### —Colloidal Silica—

In the present invention, at least one colloidal silica is preferably contained in the uppermost ink receiving layer. By containing colloidal silica in the uppermost layer, improved glossiness of the ink receiving layer surface can be obtained, and further comfortable smooth touch can be obtained.

The uppermost layer may mainly contain colloidal silica. Here, “mainly containing colloidal silica” means that the content of colloidal silica is 70 mass % or larger with respect to the total solid content (mass) of the layer. The content of colloidal silica mainly contained in the uppermost layer is preferably 80 mass % or larger and more preferably 90 mass % or larger.

In particular, when a solid coating amount of a colloidal silica is 0.3 g/m² or less, high glossiness and comfortable touch can be obtained while maintaining a high ink absorbability, and dullness (deterioration of glossiness) occurring at high density portions when images are printed with pigment inks can be improved. The lower limit of the solid coating amount of colloidal silica is 0.05 g/m². If the solid coating amount of colloidal silica is 0.05 g/m² or more, higher glossiness and comfortable touch can be obtained. The solid coating amount of colloidal silica is more preferably within a range of 0.1 to 0.25 g/m².

The colloidal silica is a colloidal aqueous dispersion of a silicon dioxide obtainable by heat-aging a silica sol obtainable by metathesis of sodium silicate with an acid or the like, or by passing sodium silicate through an ion exchange resin layer. In order to improve glossiness in a blank portion and ink absorbability, an average primary particle diameter of colloidal silica is preferably within a range of 20 to 80 nm, and more preferably within a range of 20 to 60 nm.

Examples of commercial products of colloidal silica include: product names, PL-10A, PL-3L, PL-1 and the like manufactured by Fuso Chemical Co., Ltd., and product names, SNOWTEX ST-20, ST-30, ST-40, ST-C, ST-N, ST-20L, ST-O, ST-OL, ST-S, ST-XS, ST-XL, ST-YL, ST-ZL, ST-OZL, ST-UP, ST-OUP, ST-PS-MO and the like manufactured by Nissan Chemical Industries, Ltd., all of which can be used.

Other than colloidal silica, the uppermost layer can include a hydrophilic binder, a surfactant, a pH adjusting agent and the like. In order to improve ink absorbability, the content of the hydrophilic binder is preferably 5 mass % or less with respect to the content of colloidal silica, and more preferably none.

—Components Other than Those Described Above—

Hereinafter, a detailed description of components other than those described above will be made.

### (Inorganic Fine Particles)

The ink receiving layer can be a porous layer by containing at least one kind of inorganic fine particles. Kinds of inorganic fine particles are not particularly limited. However, from viewpoints of improving glossiness and ink absorbability, use of fumed silica, alumina, or alumina hydrate is preferable. Inorganic fine particles can be used alone or in combination.

In the present invention, an ink receiving layer which contains or does not contain a pseudo boehmite alumina hydrate but contains other inorganic fine particles may be provided in addition to the ink receiving layers (including the upper ink receiving layer and the lower ink receiving layer) which contain a pseudo boehmite alumina hydrate. For example, a layered structure of three ink receiving layers may be exemplified such as the above-described upper ink receiving layer/the above-described lower ink receiving layer/a fumed silica containing ink receiving layer, or the above-described upper ink receiving layer/a fumed silica containing ink receiving layer/the above-described lower ink receiving layer.

Further, the above-described upper and lower ink receiving layers may contain inorganic fine particles other than a pseudo boehmite alumina hydrate to the extent that the effects of the invention are not damaged.

The fumed silica is also called dry method silica, in contrast to wet method silica, and is generally produced by a flame hydrolysis method. Specifically, there is a generally known method for producing fumed silica by combustion of silicon tetra chloride in hydrogen and oxygen. Instead of silicon tetra chloride, silanes, such as methyl trichloro silane and trichloro silane, may be used alone or in combinations with silicon tetra chloride. Commercially available fumed silicas may be obtained, including Product name: AEROSIL, manufactured by Nippon Aerosil Co. Ltd., and Product name: QS TYPE, manufactured by Tokuyama Corporation.

The average primary particle diameter of the fumed silica is preferably 5 to 50 nm, and in order to obtain an even higher gloss, it is preferably 5 to 20 nm with a specific surface area according to the BET method of 90 to 400 m²/g. The BET method is a method of determining the surface area of powder by gas-phase adsorption, more specifically a method of determining the specific surface area, i.e., the total surface area per g of a sample, from the adsorption isotherm. Nitrogen gas is commonly used as the adsorption gas, and most widely used is a method of determining the amount of adsorption by the change in pressure or volume of the adsorbed gas. One of the most famous equations describing the adsorption isotherm of multi-molecular system is the equation of Brunauer, Emmett, and Teller (BET equation). The surface area is calculated by multiplying the adsorption amount determined according to the BET equation by the surface area occupied by a single adsorbed molecule.

As the alumina used in the present invention, it is preferable to use γ-alumina, which are gamma phase crystals of aluminum oxide, and within the different types of alumina delta group crystals are more preferable. γ-alumina may be made into small primary particles of the order of 10 nm in size, but usually it is preferable to use particles obtained by treating secondary particles of several thousand to several tens of thousands of nm in size by applying ultrasound or by using a high pressure homogenizer, opposing jet impact pulverizer, or the like, to pulverize them to about 50 to 300 nm.

### (Other Binders)

The ink receiving layers can contain binders other than the highly saponified PVA and the low-saponified PVA as described above in order to maintain film properties. Further, when the ink receiving layers (including the upper ink receiving layer and the lower ink receiving layer) in the invention contain the highly saponified PVA or the low-saponified PVA as described above, the ink receiving layers may further contain other binders that will be described below in combination therewith. Moreover, when the ink receiving layers contain neither the highly saponified PVA nor the low-saponified PVA, they may contain binders appropriately selected from the highly saponified PVA, the low-saponified PVA described above, and binders described below.

Examples of other binders include starch or modified products thereof, gelatin or modified products thereof, natural high molecule resins such as casein, pullulan, gum arabic, karaya gum, and albumin or derivatives thereof; modified products of polyvinyl alcohol such as cationic modified polyvinyl alcohol or silanol modified polyvinyl alcohol; latices such as SBR latex, NBR latex, methylmethacrylate-butadiene copolymer, and ethylene-vinyl acetate copolymer; vinyl polymers such as polyacryl amide and polyvinyl pyrrolidone; polyethylene imine, polypropylene glycol, polyethylene glycol, and maleic anhydride or copolymers thereof, dextrin, carboxy methylcellulose, polyacrylate esters or copolymers thereof: and the like. However, the invention is not limited thereto.

Preferable examples of the binders include completely or partially saponified polyvinyl alcohols or cation modified polyvinyl alcohols.

Preferable examples of the cation modified polyvinyl alcohol include polyvinyl alcohol disclosed in JP-A No. 61-10483 and having a primary to tertiary amino group or a quaternary ammonium group in a main chain or a side chain of polyvinyl alcohol.

Examples of lattices that are used as binders include: SBR latex, and NBR latex; acrylic latex such as an alkyl, aryl, aralkyl, or hydroxyalkyl acrylate or methacrylate (e.g. ethylene-vinyl acetate copolymers); homopolymers or copolymers of acrylonitrile, acrylamide, acrylic acid and methacrylic acid; or copolymers of the aforementioned monomers and styrene sulfonic acid, vinyl sulfonic acid, itaconic acid, maleic acid, fumaric acid, maleic anhydride, vinylisocyanate, allylisocyanate, vinylmethylether, vinylacetate, styrene or divinylbenzene. Further, as olefin lattices, use of polymers (e.g. methylmethacrylate-butadiene copolymers) including copolymers of vinylmonomers and diolefins is preferable. As the vinyl monomers, use of styrene, acrylonitrile, methacrylonitrile, methyl acrylate, methyl methacrylate or vinyl acetate is preferable. As the diolefins, use of butadiene, isoprene or chloroprene is preferable.

The content of the binder in the ink receiving layer (excluding the upper ink receiving layer and the lower ink receiving layer described above) with respect to inorganic fine particles is preferably within a range of 5 to 35 mass %, and particularly preferably within a range of 10 to 30 mass %.

### (Cationic Compound)

If the ink receiving layer in the present invention contains fumed silica as inorganic fine particles, the ink receiving layer preferably contains a cationic compound together with fumed silica. By using the cationic compound in combination with the fumed silica, the ink receiving layer can be prevented from cracking and improved in water resistance.

In this case, by providing a layer (for example, an uppermost layer) containing colloidal silica and a cationic compound on an ink receiving layer containing a cationic compound, scratch resistance, water resistance, and ink absorbability can be further improved, and in addition, aggregation occurring at an interface between the two layers can be prevented, so that uneven coating or uneven glossiness can be avoided.

An ink receiving layer containing an alumina hydrate such as the above-described upper and lower ink receiving layers does not necessarily need to contain a cationic compound in combination with the alumina hydrate, and excellent cracking resistance and water resistance can be obtained without a cationic compound.

As the cationic compounds, use of cationic polymers or water-soluble multivalent metal compounds is preferable. The cationic compounds can be used alone or in combination of two or more thereof.

Examples of the cationic polymers include water-soluble cationic polymers having a quaternary ammonium group, a phosphonium group, or a primary to tertiary amine acid adduct. Examples include polyethylene imine, polydialkyldiallylamine, polyallylamine, alkylamine epichlolohydrine polycondensation product, and cationic polymers disclosed in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411, 10-193776 and the like.

A weight average molecular weight of the cationic polymer is preferably 100,000 or less, and more preferably 50,000 or less, and the lower limit thereof is about 2,000.

Further, the amount of the cationic polymer to be used is preferably within a range of 1 to 10 mass % with respect to that of pseudo boehmite alumina (containing other inorganic fine particles if contained).

Examples of multivalent metal in the water-soluble multivalent metal compound include: calcium, barium, manganese, copper, cobalt, nickel, aluminum, iron, zinc, zirconium, titanium, chromium, magnesium, tungsten, and molybdenum, all of which can be used as water soluble metal salts.

Specific examples of the water-soluble multivalent metal compounds include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zirconium acetate, zirconium nitrate, basic zirconium carbonate, zirconium hydroxide, zirconium ammonium carbonate, zirconium potassium carbonate, zirconium sulfate, zirconium fluoride, zirconium chloride, zirconium chloride octahydrate, zirconium oxychloride, zirconium hydroxychloride, titanium chloride, titanium sulfate, chromium acetate, chromium sulfate, manganese sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, and the like. Among these, water soluble salts of aluminum and elements listed in the Periodic Table IVa group (zirconium and titanium) are particularly preferable.

Here, “water soluble” means that the compound is dissolved in water in an amount of 1 mass % or more at an ordinary temperature and under an ordinary pressure.

As water soluble aluminum compounds other than the above-described compounds, a basic polyaluminum hydroxide compound may be preferably used. This compound is a water soluble polyaluminum hydroxide, the main component of which is represented by the following formula 1, 2 or 3, and which stably contains a basic and high molecular polynuclear condensation ion, such as [Al₆(OH)₁₅]³⁺, [Al₈(OH)₂₀]⁴⁺, [Al₁₃(OH)₃₄]⁵⁺, [Al₂₁(OH)₆₀]³⁺, and the like.

[Al₂(OH)ₙCl₆₋ₙ]ₘ Formula 1

[Al(OH)₃]ₙAlCl₃ Formula 2

Alₙ(OH)ₘCl(₃ₙ₋ₘ)(0<m<3n) Formula 3

These compounds of various grades can be easily obtained as a name of polyaluminum chloride (PAC) as a water treatment agent from Taki Chemical Co. Ltd., as a name of polyaluminum hydroxide (Paho) from Asada Kagaku Co. Ltd., as a name of Purachem WT from Rikengreen Co. Ltd., and as products for the similar applications from other manufacturers. In the invention, these commercially available products may be used directly. The basic polyaluminum hydroxide compounds are also disclosed in Japanese Patent Publication (JP-B) Nos. 3-24907 and 3-42591.

When the water-soluble multivalent metal compounds are contained in the ink receiving layer, the content thereof in the ink receiving layer is preferably within a range of 0.1 to 10 g/m² and more preferably 0.2 to 5 g/m².

### (Surfactant)

The ink receiving layer in the present invention may contain a surfactant. If the ink receiving layer includes a surfactant, coating failure such as coating streak of a coating film can be suppressed.

As the surfactants, use of nonionic surfactants is preferable. Other than the nonionic surfactants, anionic surfactants, cationic surfactants, nonionic surfactants, and betaine surfactants may be used. Further, high molecular surfactants and low molecular surfactants may be used, and they may be used alone or in combination of two or more thereof.

The content of the surfactant in the ink receiving layer with respect to 100 parts by mass of pseudo boehmite alumina hydrate is preferably within a range of 0.001 to 5 parts by mass, and more preferably within a range of 0.01 to 3 parts by mass.

### (Oil Droplets)

In order to improve fragility of the ink receiving layer as a film, the ink receiving layer may contain various oil droplets. Examples of the oil droplets include: a hydrophobic high boiling point organic solvents whose solubility with respect to water at a room temperature is 0.01 mass % or less (for example, liquid paraffin, dioctyl phthalate, tricresyl phosphate, and silicon oil) or polymer particles (those obtainable by polymerizing one or more polymerizable monomers such as styrene, butylacrylate, divinylbenzene, butylmethacrylate, and hydroxyethylmethacrylate). The amount of the oil droplets with respect to the hydrophilic binder is preferably within a range of 10 to 50 mass %.

### (Crosslinking Agent)

The upper ink receiving layer and the lower ink receiving layer in the present invention can contain a crosslinking agent other than boric acid or a boric acid salt in combination therewith. Further, it is preferred that the additional ink receiving layers other than the upper ink receiving layer and the lower ink receiving layer contain a crosslinking agent, together with a binder.

Specific examples of crosslinking agents include: other than the boric acid and a boric acid salt, aldehyde compounds such as formaldehyde and glutaraldehyde; ketone compounds such as diacetyl, chloropentanedione; compounds having reactive halogen such as bis(2-chloroethylurea)-2-hydroxy-4,6-dichloro-1,3,5 triazine, and those described in U.S. Pat. No. 3,288,775; compounds having reactive olefins such as divinyl sulfone and those described in U.S. Pat. No. 3,635,718; N-methylol compounds such as those described in U.S. Pat. No. 2,732,316; isocyanates such as those described in U.S. Pat. No. 3,103,437; aziridine compounds such as those described in U.S. Pat. Nos. 3,017,280 and 2,983,611; and carbodiimide compounds such as those described in U.S. Pat. No. 3,100,704; epoxy compounds such as those described in U.S. Pat. No. 3,091,537; and the halogen carboxyaldehydes such as mucochloric acid; dioxane derivatives like dihydroxydioxane; and inorganic hardening agent such as chrome alum, and zirconium sulfate. These may be used singly or in combination of two or more thereof.

Among these, boric acid or a boric acid salt are particularly preferable.

The addition amount of a crosslinking agent with respect to a hydrophilic binder for forming the ink receiving layer is preferably within a range of 0.1 to 40 mass %, and more preferably within a range of 0.5 to 30 mass %.

Other than the aforementioned compounds, the ink receiving layer in the present invention may contain various known additives such as coloring dye, coloring pigment, fixer of ink dye, UV absorbent, antioxidant, dispersing agent of pigment, defoaming agent, leveling agent, antiseptic agent, fluorescent whitening agent, viscosity stabilizer, and pH adjusting agent.

In a coating liquid for forming an ink receiving layer (coating liquid for the ink receiving layer), pH preferably falls within a range of 3.3 to 6.0, and particularly preferably within a range of 3.5 to 5.5. By combining such a pH of the ink receiving layer coating liquid with a pH(=3.3 to 6) of the coating liquid for forming the uppermost layer containing colloidal silica, the ink receiving layer can exhibit excellent ink absorbability, excellent glossiness, and uniform coating surface.

Further, in order to increase image resolution, the ink receiving layer may contain fluorine resin-based, silicone resin-based or alkyl ketene dimmer-based water repellent agents or sizing agents, as long as no aggregation takes place when the water repellent agents or the sizing agents are mixed with an alumina hydrate dispersion liquid, whereby image resolution may be improved by controlling a printing dot diameter. A commercially available product can be used for the water-repellent agent or the sizing agent, which may be of either a solution type or a water base emulsion type. The printing dot diameter may be controlled by adjusting the adding amount of the sizing agent or the water-repellent agent to the ink receiving layer. The adding amount of the sizing agent or the water-repellent agent may vary in accordance with components, concentration or a desired printing dot diameter. However, as an effective solid component, it is ordinarily within a range of 0.05 to 10 mass %, and preferably 0.1 to 5 mass % with respect to the total solid content of the ink receiving layer.

Preparation of a coating liquid (ink receiving layer coating liquid) for forming the two ink receiving layers (including the above-described upper and lower ink receiving layers) for constituting the inkjet recording medium of the invention may be conducted as described below.

First, pseudo boehmite alumina hydrate is added to water (e.g. ion exchanged water) and stirred by a stirrer such as a dissolver or a vacuum disperser to prepare a coarse dispersion liquid. This is further finely dispersed by a high pressure disperser or a bead mill to obtain an alumina-containing dispersion liquid. Subsequently, the alumina containing dispersion liquid is stirred and mixed together with polyvinyl alcohol (containing the highly saponified PVA in the case of the upper ink receiving layer and low-saponified PVA in the case of the lower ink receiving layer), boric acid and/or a boric acid salt (crosslinking agent), and other components as necessary. Here, the components are preferably mixed with each other while adjusting the temperature of each of the components (such as each aqueous solution containing each component) to a desired temperature (preferably 40 to 70° C.), and maintaining each component at the desired temperature (preferably 40 to 70° C.).

As a high pressure disperser, an altimizer (such as HJP25005 manufactured by Sugino Machine K.K.) in which the pressurized materials in a slurry form are made to collide with each other at high speed to be pulverized, an ultrasonic dispersing apparatus utilizing cavitation, a gaulin homogenizer of homo valve type or the like can be used. As the bead mill, an ultra apecs mill (UAM-10 manufactured by KOTOBUKI INDUSTRIES CO., LTD.) utilizing tripology shear force, a star mill (NANO GETTER DMR65) manufactured by Ashizawa Finetech Ltd.) or the like can be used.

When pseudo boehmite alumina hydrate and binder such as PVA are mixed with each other, viscosity is easily increased with an elapse of time and thixotropy property is exhibited. However, by control of the temperature of a coating liquid, the change of viscosity with time can be inhibited. Accordingly, coating stability can be improved to thereby well maintain the quality of a film of a coating surface.

Temperature of the coating liquid is preferably within a range of 30 to 70° C., and more preferably within a range of 40 to 50° C. If the temperature of the coating liquid is 30° C. or higher, thixotropy property of the coating liquid can be suppressed to conduct excellent coating. If the temperature of the coating liquid is 70 C or lower, coating failure such as occurrences of coating streak during a film coating can be suppressed.

From viewpoints of improving a coatability of the coating liquid or controlling a dot diameter of ink when it is adhered to the ink receiving layer, surfactants are preferably added to the coating liquid for forming the ink receiving layer. A detailed description of the surfactant has already been made in the above description.

### —Water Resistance Support—

A water resistance support for constituting the inkjet recording medium of the present invention is not particularly limited. However, the support may be a resin coated paper having a resin coating layer at both sides of a base paper or a transparent plastic support such as a transparent support using a polyester resin.

Examples of pulps to be used for a base paper for constituting a resin coated paper include chemical pulps such as LBKP, NBKP, LBSP, NBSP, LUKP, NUKP, LUSP and NUSP, virgin pulps such as mechanical pulps such as GP and TMP, and recycled pulps from newspaper, magazines, office waste paper and the like.

White pigment, whose average particle diameter is within a range of 0.3 to 10 μm, such as at least one selected from the group of calcium carbonate, magnesium carbonate, talc, kaolin, silica, alumina, titanium dioxide, barium sulfate or the like is used as a filler in the base paper in an amount of 2 to 30 mass % and preferably 4 to 30 mass % with respect to the total solid matter of the total pulp. White pigment whose average particle diameter is smaller than 0.3 μm may not remain in paper after paper-making, while white pigment whose average particle diameter is larger than 10 μm may deteriorate the texture of paper. White pigments whose whiteness is 88% or higher according to JIS-M8016 is preferably used. If the content of white pigment is less than 2 mass % of the base paper, satisfactorily white base paper may be hard to obtain. If the content of white pigment is more than 30 mass % of the base paper, a problem of stains during the manufacture of the base paper may be caused, and strength of the base paper may be deteriorated. The base paper may be blended with additives such as various sizing agents, paper strength enhancers, antistatic agents, fluorescent whitening agents, dyes or the like generally used for paper making.

Further, surface sizing agents, surface paper strength agents, fluorescent whitening agents, antistatic agents, dyes, anchoring agents or the like can be coated on the surface of the base paper.

Preferable thickness of the base paper is within a range of 70 to 200 μm. Thickness may be adjusted by compressing paper by applying pressure using a calendar during or after paper making. The base paper whose surface smoothness is higher is preferable. However, if the compression is excessive, the degree of whiteness is easily deteriorated.

Examples of resins include: a polyolefin resin such as olefin homopolymers such as low density polyethylene having a density of 0.91 to 0.93 g/cm³, high density polyethylene having a density of 0.94 to 0.96 g/cm³, a medium density polyethylene having a medium density, polypropylene, polybutene, and polypentene, copolymers formed of two or more olefins such as ethylene-propylene copolymers, and their mixtures; and a resin such as polyvinyl chloride, polyvinylidene chloride, polymethyl methacrylate, or polystyrene, having various densities and melt viscosity indices (melt indices), the resins being used alone or in combination. From a viewpoint of easy handling, the polyolefin resin is preferably used, and the low density polyethylene having a density of 0.91 to 0.93 g/cm³ is particularly preferably contained in an amount of 50 mass % or more with respect to the total resin solid content of the resin coating layer.

At least one white pigment whose average particle diameter is within a range of 0.1 to 1 μm and which is selected from the group consisting of titanium dioxide, barium sulfate, zinc oxide, calcium carbonate, and magnesium carbonate may be contained in a resin coating layer at least at a side at which an ink receiving layer is provided, of a resin coated paper, in an amount of 5 to 20 mass %, and preferably 7 to 15 mass %, with respect to the total resin solid content. White pigment whose average particle diameter is smaller than 0.1 μm may provide less concealing effects, and that whose average particle diameter is larger than 1 μm may deteriorate surface properties of the resin coating layer. Use of white pigment whose degree of whiteness is 88% or higher according to JIS-M8016 is particularly preferable. If the content of white pigment with respect to the total solid content of the resin is 5 mass % or more, the resin coated paper can exhibit sufficient opaqueness even with a thin base paper. On the other hand, if the content of white pigment with respect to the total solid content of the resin is 20 mass % or less, the surface of the resin coating layer can be prevented from becoming uneven due to occurrences of scratch or the like, whereby surface strength can be maintained. Other additives can be added in appropriate combination, and examples thereof include various additives such as fatty acid amide such as stearic acid amide or arachidic acid amide, metal salts of fatty acids such as zinc stearate, calcium stearate, aluminum stearate, and magnesium stearate, antioxidants such as Illuganox 1010 and Illuganox 1076, blue pigment or dyes such as cobalt blue, ultramarine blue, cecilian blue and phthalocyanine blue, magenta pigments or dyes such as cobalt violet, fast violet and manganese violet, fluorescent bleaching agents, and ultraviolet absorbing agents.

The resin coated paper is generally produced by a so-called extruding coating method in which a heated and melted thermoplastic resin is flowed onto a running base paper to coat the base paper with the resin. Further, it is preferred to conduct an activation treatment such as a corona discharge treatment or a flame treatment on the base paper before the base paper is coated with the resin. Although the back surface resin coating layer on the base paper is ordinarily not glossy, the activation treatment such as the corona discharge treatment or the flame treatment may be conducted either on the front surface or both (front and back) surfaces of the base paper as necessary.

A front side resin layer of the resin coated paper, on which the ink absorbing layer is coated, is mainly produced such that a thermoplastic resin is heated and melted by an extruder and extruded into between the base paper and a cooling roll in a film state, adhered by pressure, and cooled. At this point, the cooling roll is used for forming the surface shape of the resin coating layer, and in accordance with the shape of the cooling roll surface, the surface of the resin layer is formed (embossed) into a mirrored surface, a finely roughened surface or a patterned surface such as a silk finish, a matte finish or the like.

The back side resin layer at the opposite side of the front side resin layer of the resin coated paper can also be produced by heating, melting, and extruding the resin by the extruder into between the base paper and the cooling roll in a film state, adhering by pressure, and cooling. At this point, from a viewpoint of transportability in a priner, preferably, the resin layer surface is formed (embossed) into a finely roughened surface or a patterned surface such as a silk finish or a matte finish in accordance with the shape of the cooling roll surface so as to have an Ra according to JIS-B-0601 of 0.8 to 5 μm.

As a method of providing the resin coating layer on the base paper, other than the method of coating a resin by extruding a heat melted resin, there are provided a method of irradiating an electron beam after coating an electron beam curable resin, and a method of coating a polyolefin resin emulsion coating liquid, drying the coated resin, and conducting a surface smoothing treatment of the coated resin. Both methods can provide a resin coated paper suitable for the present invention by conducting a shaping (embossing) process using a heat roll having concave portions and convex portions or the like.

In order to improve adhesiveness, an undercoat layer may be provided on the front side surface of the resin coated paper. The undercoat layer is coated and dried on the resin layer surface of the support in advance before an ink receiving layer is coated thereon. The undercoat layer is a layer mainly containing a water soluble polymer or a polymer latex from which a film can be formed, and a water soluble polymer such as gelatin, polyvinyl alcohols, polyvinyl pyrrolidone or water-soluble cellulose is preferably used, and use of gelatin is particularly preferable. The amount of the water-soluble polymer adhered is preferably in a range of 10 to 500 mg/m², and more preferably in a range of 20 to 300 mg/m². It is preferred that the undercoat layer further contains surfactants and film hardening agents. Moreover, before the undercoat layer is formed (by coating or the like) on the resin coated paper, a corona discharge treatment is preferably conducted.

The inkjet recording medium of the present invention includes two or more ink receiving layers on a water-resistant support. The two or more ink receiving layers may be formed by simultaneous multi-coating of two or more coating liquids for forming an ink receiving layer, or may be formed by coating and drying one of the coating liquids, followed by coating the other coating liquids thereon.

Physical properties of the ink receiving layer may be controlled by appropriately selecting coating conditions (such as a coater, temperature of a coating liquid and viscosity) and drying conditions (such as drying temperature, drying time, temperature gradient, airflow amount, a method of applying airflow, and moisture) when the ink receiving layer is formed by coating.

The temperature for drying a coating film formed by coating varies in accordance with heat resisting properties of the support. However, it is preferably within a range of 10 to 100° C., and more preferably within a range of 20 to 80° C.

Further, after coating, the ink receiving layer is sufficiently dried, and thereafter, is subjected to a heat treatment to the extent that the support is not adversly affected, whereby a pore volume of the ink receiving layer can be made larger thus making it possible to improve ink absorbability and water resistance. The temperature for conducting a heat treatment varies in accordance with heat resisting properties of the support. However, it is preferably within a range of 30 to 80° C., and more preferably within a range of 40 to 60° C.

### EXAMPLES

The present invention will be described in detail with reference to the examples. However, the following examples do not limit the scope of the invention. “Parts” and “%” in the examples means “parts by mass” and “% by mass” unless otherwise specified.

### Example 1

### —Preparation of Alumina White Color Transparent Dispersion Liquid—

708 g of CATALOID AP-5 (manufactured by Catalysts & Chemicals Industries, Co., Ltd.: pseudo boehmite alumina hydrate) was added to 2042 g of ion exchange water while being stirred using a dissolver to obtain a white color alumina coarse dispersion liquid. Rotation frequency of the dissolver was 3000 r.p.m, and rotation time was 10 minutes.

Then, this alumina coarse dispersion liquid was finely dispersed by using a high pressure disperser (ALTIMIZER HJP25005, manufactured by Sugino Machine K.K.) to obtain a white color transparent alumina dispersion liquid having a solid content of 25%. In this case, the pressure was 100 Mpa, and the discharge amount was 600 g/min.

The particle diameter of the dispersed particles of the obtained alumina white color transparent dispersion liquid was 0.1040 μm.

### —Formation of a First Ink Receiving Layer (Lower Ink Receiving Layer)—

100 parts of the obtained alumina white color transparent dispersion liquid, 34 parts of a 7% aqueous solution of PVA-220 (polyvinyl alcohol having a saponification degree of 88% and a polymerization degree of 2000, manufactured by Kuraray Co., Ltd., low-saponified PVA), 9.6 parts of a 7.5% aqueous solution of boric acid, 1.38 parts of a 10% aqueous solution of a surfactant (Emulgen 109P, manufactured by Kao Corporation, HLB: 13.6, a surfactant), and 50.6 parts of ion exchange water were heated to the temperature of 60° C. before mixing, and were mixed sufficiently while maintaining the temperature at 60° C. to prepare a coating liquid for a lower ink receiving layer (hereinafter, “lower ink receiving layer coating liquid”). Here, a mass ratio (A/B2) of pseudo boehmite alumina (A) to polyvinyl alcohol (B2) was 10.

Then, the lower ink receiving layer coating liquid was cooled to 50° C., followed by an ultrasonic defoaming treatment for 10 minutes, while maintaining the temperature at 50° C. Immediately after the ultrasonic defoaming treatment, the lower ink receiving layer coating liquid was coated on a transparent polyester film (product name: Lumirror 125T manufactured by Toray Industries, Inc., haze (hazing value)=2.19 according to JIS-K-7105, on which a surface treatment for raising adhesiveness was finished; hereinafter, simply referred to as a “transparent support”) to provide a pseudo boehmite alumina solid content after drying of 35 g/m². After coating, the coating film was set-dried for two minutes to have a film surface temperature of 20° C., and thereafter, dried for 10 minutes at 80° C., whereby a lower ink receiving layer was formed.

### —Formation of a Second Ink Receiving Layer (Upper Ink Receiving Layer)—

100 parts of the alumina white color transparent dispersion liquid obtained as described above, 10 parts of a 7% aqueous solution of PVA-124 (polyvinyl alcohol having a saponification degree of 99% and a polymerization degree of 2400, manufactured by Kuraray Co., Ltd.; highly saponified PVA), 3 parts of a 7.5% of aqueous boric acid solution, 0.01 parts of a 10% aqueous surfactant solution (Emulgen 109P manufactured by Kao Corporation, HLB: 13.6; surfactant), and 50.6 parts of ion exchange water were heated to the temperature of 60° C. before mixing, and were mixed sufficiently while maintaining the temperature at 60° C. to prepare a coating liquid for a upper ink receiving layer (hereinafter, “upper ink receiving layer coating liquid”). Here, a mass ratio (A/B1) of pseudo boehmite alumina (A) to polyvinyl alcohol (B1) was 10.

The upper ink receiving layer coating liquid was cooled to the temperature of 50° C. Thereafter, this was subjected to an ultrasonic defoaming treatment for 10 minutes, while maintaining the temperature at 50° C. Immediately after the ultrasonic defoaming treatment, the upper ink receiving layer coating liquid was coated on the ink receiving layer (lower ink receiving layer) that was coated on the transparent polyester film to provide a pseudo boehmite alumina solid content after drying of 5 g/m². This was set-dried for two minutes to have a film surface temperature of 20° C., and thereafter, dried for 10 minutes at 80° C., whereby an upper ink receiving layer was formed.

As described above, an inkjet recording medium having a layer structure of a transparent support/an ink receiving layer (lower ink receiving layer)/an ink receiving layer (upper ink receiving layer) in this order was produced. In the inkjet recording medium according to Example 1, the upper ink receiving layer is the uppermost layer.

### Example 2

An inkjet recording medium was produced in the same manner as in Example 1, except that the content of PVA-124 in the upper ink receiving layer coating liquid was changed from 10 parts to 15 parts in Example 1.

### Example 3

An inkjet recording medium was produced in the same manner as in Example 1, except that 3 parts of Sharol DC402P (an aqueous solution of polydiallyldimethyl ammonium chloride, manufactured by DAI-ICHI KOGYO SEIYAKU CO., LTD.) were added to the upper ink receiving layer coating liquid in Example 1.

### Example 4

An inkjet recording medium was produced in the same manner as in Example 1, except that the content of PVA-220 used for the preparation of the lower ink receiving layer coating liquid was changed from 10 parts to 8 parts in Example 1.

Further, a mass ratio (A/B2) of pseudo boehmite alumina hydrate (A) to low-saponified PVA (B2) was 10 or more.

### Example 5

An inkjet recording medium was produced in the same manner as in Example 1, except that PVA-220 (low-saponified PVA) used for the preparation of the lower ink receiving layer coating liquid was replaced by PVA-245 (saponification degree: 88%, average polymerization degree: 3500, manufactured by Kuraray Co., Ltd.), and PVA-124 (highly saponified PVA) used for the preparation of the upper ink receiving layer coating liquid was replaced by PVA-145 (saponification degree: 99%, average polymerization degree: 4500, manufactured by Kuraray Co., Ltd.) in Example 1.

### Example 6

An inkjet recording medium was produced in the same manner as in Example 1, except that PVA-220 (low-saponified PVA) used for the preparation of the lower ink receiving layer coating liquid was replaced by PVA-424 (saponification degree: 78%, average polymerization degree: 2400, manufactured by Kuraray Co., Ltd.) in Example 1.

### Example 7

An inkjet recording medium was produced in the same manner as in Example 1, except that PVA-124 (highly saponified PVA) used for the preparation of the upper ink receiving layer coating liquid was replaced by JM33 (saponification degree: 95%, average polymerization degree: 3300, manufactured by The Nippon Synthetic Chemical Industry Co., Ltd.), in Example 1.

### Example 8

An inkjet recording medium was produced in the same manner as in Example 1, except that a colloidal silica-containing layer coating liquid having the following composition was further coated on the ink receiving layer (upper ink receiving layer) so as to provide a coating amount of colloidal silica of 0.2 g/m² and dried to form an uppermost layer in Example 1.

<Composition of colloidal silica-containing layer coating liquid>

| | | |
|---|---|---|
| PL-3L (colloidal silica; manufactured by Fuso Chemical | 0.5 | parts |
| Co., Ltd.) | | |
| POLYFIX 700 (manufactured by Showa High Polymer | 0.1 | parts |
| Co., Ltd.) | | |
| 7% aqueous solution of PVA-117 (manufactured by | 0.6 | parts |
| Kuraray Co., Ltd.) | | |
| Swanol AM 3130 (manufactured by Nihon Surfactant | 0.0015 | parts |
| Kogyo K.K.) | | |

### Comparative Example 1

A comparative inkjet recording medium was prepared in the same manner as in Example 1, except that PVA-220 (low-saponified PVA) used for the preparation of the lower ink receiving layer coating liquid was replaced by PVA-124 (saponification degree: 99%, polymerization degree: 2400, manufactured by Kuraray Co., Ltd.) in Example 1.

### Comparative Example 2

A comparative inkjet recording medium was prepared in the same manner as in Example 1, except that PVA-124 (highly saponified PVA) used for the preparation of the upper ink receiving layer coating liquid was replaced by PVA-220 (saponification degree: 88%, polymerization degree: 2000, manufactured by Kuraray Co., Ltd.) in Example 1.

### Comparative Example 3

A comparative inkjet recording medium was prepared in the same manner as in Example 1, except that PVA-220, which was used in the lower ink receiving layer in Example 1, was used in the upper ink receiving layer, and PVA-124, which was used in the upper ink receiving layer in Example 1, was used in the lower ink receiving layer.

### Comparative Example 4

A comparative inkjet recording medium was prepared in the same manner as in Example 1, except that PVA-124 used in the upper ink receiving layer was replaced by PVA-424 (saponification degree: 78%, average polymerization degree: 2400, manufactured by Kuraray Co., Ltd.) in Example 1.

### (Evaluation)

As for the respective inkjet recording media thus obtained in the above-described Examples and Comparative Examples, the following measurements and evaluations were conducted. The results are shown in Table 1 below:

### 1) Image Printing Density

Black (Bk) solid-printing was performed by using Inkjet Printer PM-A950 (manufactured by Seiko Epson Corporation). Image printing density of the solid printed area was measured by using Spectrolino™ SPM50 (manufactured by GretagMacbeth AG) under the conditions of visibility angle: 2°, light source: D50, and filterless.

### 2) Bronzing

Solid-printing of cyan color was performed by using Inkjet Printer PM-A820 (manufactured by Seiko Epson Corporation) at 35° C./80% RH atmosphere and visual observation of the solid printed area was performed under a fluorescent lamp, and evaluated on the basis of the following evaluation criteria.

### <Evaluation Criteria>

A: Reflected fluorescent light did not look reddish, and clear cyan color was maintained.
B: Reflected fluorescent light slightly looked reddish.
C: Reflected fluorescent light looked reddish.
D: Reflected fluorescent light entirely looked reddish.

### 3) Haze

Inkjet Printer PM-G800 (manufactured by Seiko Epson Corporation) was prepared, empty ink tanks were filled with ink solvents of respective colors, and an operation similar to solid-printing was performed. Three hours after the printing operation, the haze value was measured by using a haze meter (product name: HGM-2DP, manufactured by Suga Test Instrument Co., Ltd.).

### 4) Scratch Resistance

Solid printing of black (Bk) was performed by using Inkjet Printer PM-G800 (manufactured by Seiko Epson Corporation), and the scratches formed during printing in the solid printed area were observed under a fluorescent lamp, and evaluated on the basis of the following evaluation criteria.

### <Evaluation Criteria>

AA: No scratches were observed.
BB: Slight scratches were observed.
CC: Thick scratches were observed.

### 5) Ink Absorption Rate

Color Inkjet Printer PM-A820 (manufactured by Seiko Epson Corporation) was used to record images, and the time required from the state in which the recording was finished to the state in which the printed area was rubbed softly with a finger but the finger did not become dirty was measured, and evaluation was performed according to the following evaluation criteria. Acceptable degree is 4 or more.

### <Evaluation Criteria>

5: Ink absorption rate was less than 10 seconds.
4: Ink absorption rate was within a range of 10 to less than 30 seconds.
3: Ink absorption rate was within a range of 30 to less than 60 seconds.
2: Ink absorption rate was within a range of 1 to less than 5 minutes.
1: Ink absorption rate was 5 minutes or more.

### 6) Glossiness

Inkjet printer PM-A950 (manufactured by Seiko Epson Corporation) was used to perform solid printing of Black (Bk). Glossiness of the solid printed image area was measured using a digital glossimeter UGV-5D (measuring pore: 8 mm, manufactured by Suga Test Instruments Co., Ltd.) at an incident angle of 60° and at a light reception of 60°.

TABLE 1

| | Ink Receiving Layer (lower | | | Ink Receiving Layer | | | | |
|---|---|---|---|---|---|---|---|---|
| | ink receiving layer) | | | (upper ink receiving layer) | | | | |
| | Pseudo | | Cross- | Pseudo | | Cross- | | Colloidal |
| | boehmite | | linking | boehmite | | linking | Cationic | silica |
| | alumina | Binder | agent | alumina | Binder | agent | polymer | layer |
| Example 1 | AP-5 | PVA-220 | Boric | AP-5 | PVA-124 | Boric | — | — |
| | (100 parts) | (10 parts) | acid | (100 parts) | (10 parts) | acid | | |
| | | | (3 parts) | | | (3 parts) | | |
| Example 2 | AP-5 | PVA-220 | Boric | AP-5 | PVA-124 | Boric | — | — |
| | (100 parts) | (10 parts) | acid | (100 parts) | (15 parts) | acid | | |
| | | | (3 parts) | | | (3 parts) | | |
| Example 3 | AP-5 | PVA-220 | Boric | AP-5 | PVA-124 | Boric | Sharol | — |
| | (100 parts) | (10 parts) | acid | (100 parts) | (10 parts) | acid | DC402P | |
| | | | (3 parts) | | | (3 parts) | (3parts) | |
| Example 4 | AP-5 | PVA-220 | Boric | AP-5 | PVA-124 | Boric | — | — |
| | (100 parts) | (8 parts) | acid | (100 parts) | (10 parts) | acid | | |
| | | | (3 parts) | | | (3 parts) | | |
| Example 5 | AP-5 | PVA-245 | Boric | AP-5 | PVA-145 | Boric | — | — |
| | (100 parts) | (10 parts) | acid | (100 parts) | (10 parts) | acid | | |
| | | | (3 parts) | | | (3 parts) | | |
| Example 6 | AP-5 | PVA-424 | Boric | AP-5 | PVA-124 | Boric | — | — |
| | (100 parts) | (10 parts) | acid | (100 parts) | (10 parts) | acid | | |
| | | | (3 parts) | | | (3 parts) | | |
| Example 7 | AP-5 | PVA-220 | Boric | AP-5 | JM33 | Boric | — | — |
| | (100 parts) | (10 parts) | acid | (100 parts) | (10 parts) | acid | | |
| | | | (3 parts) | | | (3 parts) | | |
| Example 8 | AP-5 | PVA-220 | Boric | AP-5 | PVA-124 | Boric | — | Present |
| | (100 parts) | (10 parts) | acid | (100 parts) | (10 parts) | acid | | (PL-3L) |
| | | | (3 parts) | | | (3 parts) | | |
| Comparative | AP-5 | PVA-124 | Boric | AP-5 | PVA-124 | Boric | | — |
| Example 1 | (100 parts) | (10 parts) | acid | (100 parts) | (10 parts) | acid | | |
| | | | (3 parts) | | | (3 parts) | | |
| Comparative | AP-5 | PVA-220 | Boric | AP-5 | PVA-220 | Boric | — | — |
| Example 2 | (100 parts) | (10 parts) | acid | (100 parts) | (10 parts) | acid | | |
| | | | (3 parts) | | | (3 parts) | | |
| Comparative | AP-5 | PVA-124 | Boric | AP-5 | PVA-220 | Boric | — | — |
| Example 3 | (100 parts) | (10 parts) | acid | (100 parts) | (10 parts) | acid | | |
| | | | (3 parts) | | | (3 parts) | | |
| Comparative | AP-5 | PVA-220 | Boric | AP-5 | PVA-424 | Boric | — | — |
| Example 4 | (100 parts) | (10 parts) | acid | (100 parts) | (10 parts) | acid | | |
| | | | (3 parts) | | | (3 parts) | | |

| | | | Haze | | | | Ink |
|---|---|---|---|---|---|---|---|
| | Printing | | Before | After | 60° | Scratch | absorbing |
| | density | Bronzing | printing | printing | Glossiness | resistance | rate |
| Example 1 | 2.80 | B | 9.8 | 18.5 | 48 | AA | 4 |
| Example 2 | 2.75 | A | 9.9 | 19 | 50 | AA | 5 |
| Example 3 | 2.80 | A | 10 | 18.3 | 46 | AA | 5 |
| Example 4 | 2.90 | B | 9 | 17 | 48 | AA | 4 |
| Example 5 | 2.95 | B | 8.5 | 16.5 | 47 | AA | 4 |
| Example 6 | 2.90 | B | 9.2 | 17 | 49 | AA | 4 |
| Example 7 | 2.85 | B | 9.6 | 18 | 45 | AA | 5 |
| Example 8 | 2.80 | B | 9.8 | 18.5 | 65 | AA | 4 |
| Comparative | 2.60 | B | 10.5 | 22 | 42 | AA | 5 |
| Example 1 | | | | | | | |
| Comparative | 2.86 | C | 9.5 | 18 | 48 | BB | 3 |
| Example 2 | | | | | | | |
| Comparative | 2.70 | C | 10 | 17.5 | 44 | BB | 3 |
| Example 3 | | | | | | | |
| Comparative | 2.75 | D | 9 | 16.6 | 38 | CC | 3 |
| Example 4 | | | | | | | |

Cf) values (parts) shown in parentheses in columns of the ink receiving layer (upper ink receiving layer) and the ink receiving layer (lower ink receiving layer) represent solid state contents.

As shown in Table 1, extremely high density images were obtained, and occurrences of image bronzing were effectively suppressed in the Examples. In particular, in the case of Example 4 in which the mass ratio (A/B2) of pseudo boehmite alumina to a PVA (B2) having a low saponification degree and a high polymerization degree in the lower ink receiving layer was 10 or more and Example 5 in which the average polymerization degrees of the highly saponified PVA in the upper ink receiving layer and the low-saponified PVA in the lower ink receiving layer were 3000 or higher, higher image density was obtained. Further, in the case of Example 2 in which the mass ratio (A/B1) of the pseudo boehmite alumina to the highly saponified PVA in the upper ink receiving layer was 8 or less and Example 3 in which 3 parts of a quaternary ammonium salt cationic polymer was added to the upper ink receiving layer, excellent bronzing-prevention effects were obtained.

On the other hand, in the case of Comparative Examples 2 to 4 in which low-saponified PVA was used in the upper ink receiving layer, bronzing was not prevented effectively. Further, in the case of Comparative Example 1 in which highly saponified PVA was used in the lower ink receiving layer, image printing density was particularly poor.

Exemplary embodiments of the invention include the following (1) to (17).

(1) An inkjet recording medium comprising a water-resistant support, and on the water-resistant support, two or more ink receiving layers including an upper ink receiving layer and a lower ink receiving layer, the upper ink receiving layer being farther from the water-resistant support than the lower ink receiving layer, the lower ink receiving layer being nearer to the water resistant support than the upper ink receiving layer, and each of the two or more ink receiving layers containing a pseudo boehmite alumina hydrate, wherein

the upper ink receiving layer further contains a polyvinyl alcohol (B1) having a saponification degree of 90% or higher and at least one crosslinking agent selected from the group consisting of boric acid and boric acid salts, and

the lower ink receiving layer further contains a polyvinyl alcohol (B2) having a saponification degree of less than 90% and at least one cross-linking agent selected from the group consisting of boric acid and boric acid salts.

(2) The inkjet recording medium of (1), wherein the polyvinyl alcohol (B1) contained in the upper ink receiving layer has a saponification degree of from 95% to less than 100%.

(3) The inkjet recording medium of (1), wherein the polyvinyl alcohol (B2) contained in the lower ink receiving layer has a saponification degree of from 75% to less than 90%.

(4) The inkjet recording medium of (3), wherein the polyvinyl alcohol (B2) contained in the lower ink receiving layer has a saponification degree of from 85% to less than 90%.

(5) The inkjet recording medium of (1), wherein a mass ratio (A/B1) of the pseudo boehmite alumina hydrate (A) to the polyvinyl alcohol (B1) in the upper ink receiving layer is 8 or less.

(6) The inkjet recording medium of (5), wherein the mass ratio (A/B1) is within a range of 4 to 7.

(7) The inkjet recording medium of (1), wherein an uppermost ink receiving layer, which is farthest from the water-resistant support in the two or more ink receiving layers, further contains a quaternary ammonium salt cationic polymer.

(8) The inkjet recording medium of (1), wherein a mass ratio (A/B2) of the pseudo boehmite alumina hydrate (A) to the polyvinyl alcohol (B2) in the lower ink receiving layer is 10 or more.

(9) The inkjet recording medium of (8), wherein the mass ratio (A/B2) is within a range of 10 to 15.

(10) The inkjet recording medium of (1), wherein at least one of the polyvinyl alcohol (B1) or the polyvinyl alcohol (B2) has an average polymerization degree of 3000 or higher.

(11) The inkjet recording medium of (1), further comprising a colloidal silica containing layer on the ink receiving layers.

(12) The inkjet recording medium of (1), wherein the content of the pseudo boehmite alumina hydrate in the ink receiving layers is within a range of 60 to 95 mass %.

(13) The inkjet recording medium of (12), wherein the content of the pseudo boehmite alumina hydrate in the ink receiving layers is within a range of 70 to 90 mass %.

(14) The inkjet recording medium of (1), wherein the content of the polyvinyl alcohol (B1) having a saponification degree of 90% or higher in the upper ink receiving layer is within a range of 8 to 25 mass %.

(15) The inkjet recording medium of (14), wherein the content of the polyvinyl alcohol (B1) having a saponification degree of 90% or higher in the upper ink receiving layer is within a range of 10 to 20 mass %.

(16) The inkjet recording medium of (1), wherein the content of the polyvinyl alcohol (B2) having a saponification degree of less than 90% in the lower ink receiving layer is within a range of 5 to 10 mass %.

(17) The inkjet recording medium of (16), wherein the content of the polyvinyl alcohol (B2) having a saponification degree of less than 90% in the lower ink receiving layer is within a range of 6 to 8 mass %.

The present invention can provide an inkjet recording medium in which occurrences of bronzing can be prevented in an ink receiving layer containing pseudo boehmite alumina hydrate and overwhelmingly high image density can be obtained.

What is claimed is:

1. An inkjet recording medium comprising a water-resistant support, and on the water-resistant support, two or more ink receiving layers including an upper ink receiving layer and a lower ink receiving layer, the upper ink receiving layer being farther from the water-resistant support than the lower ink receiving layer, the lower ink receiving layer being nearer to the water resistant support than the upper ink receiving layer, and each of the two or more ink receiving layers containing a pseudo boehmite alumina hydrate, wherein
the upper ink receiving layer further contains a polyvinyl alcohol (B1) having a saponification degree of 90% or higher and at least one crosslinking agent selected from the group consisting of boric acid and boric acid salts, and
the lower ink receiving layer further contains a polyvinyl alcohol (B2) having a saponification degree of less than 90% and at least one cross-linking agent selected from the group consisting of boric acid and boric acid salts.

2. The inkjet recording medium of claim 1, wherein the polyvinyl alcohol (B1) contained in the upper ink receiving layer has a saponification degree of from 95% to less than 100%.

3. The inkjet recording medium of claim 1, wherein the polyvinyl alcohol (B2) contained in the lower ink receiving layer has a saponification degree of from 75% to less than 90%.

4. The inkjet recording medium of claim 3, wherein the polyvinyl alcohol (B2) contained in the lower ink receiving layer has a saponification degree of from 85% to less than 90%.

5. The inkjet recording medium of claim 1, wherein a mass ratio (A/B1) of the pseudo boehmite alumina hydrate (A) to the polyvinyl alcohol (B1) in the upper ink receiving layer is 8 or less.

6. The inkjet recording medium of claim 5, wherein the mass ratio (A/B1) is within a range of 4 to 7.

7. The inkjet recording medium of claim 1, wherein an uppermost ink receiving layer, which is farthest from the water-resistant support in the two or more ink receiving layers, further contains a quaternary ammonium salt cationic polymer.

8. The inkjet recording medium of claim 1, wherein a mass ratio (A/B2) of the pseudo boehmite alumina hydrate (A) to the polyvinyl alcohol (B2) in the lower ink receiving layer is 10 or more.

9. The inkjet recording medium of claim 8, wherein the mass ratio (A/B2) is within a range of 10 to 15.

10. The inkjet recording medium of claim 1, wherein at least one of the polyvinyl alcohol (B1) or the polyvinyl alcohol (B2) has an average polymerization degree of 3000 or higher.

11. The inkjet recording medium of claim 1, further comprising a colloidal silica containing layer on the ink receiving layers.

12. The inkjet recording medium of claim 1, wherein the content of the pseudo boehmite alumina hydrate in the ink receiving layers is within a range of 60 to 95 mass %.

13. The inkjet recording medium of claim 12, wherein the content of the pseudo boehmite alumina hydrate in the ink receiving layers is within a range of 70 to 90 mass %.

14. The inkjet recording medium of claim 1, wherein the content of the polyvinyl alcohol (B1) having a saponification degree of 90% or higher in the upper ink receiving layer is within a range of 8 to 25 mass %.

15. The inkjet recording medium of claim 14, wherein the content of the polyvinyl alcohol (B1) having a saponification degree of 90% or higher in the upper ink receiving layer is within a range of 10 to 20 mass %.

16. The inkjet recording medium of claim 1, wherein the content of the polyvinyl alcohol (B2) having a saponification degree of less than 90% in the lower ink receiving layer is within a range of 5 to 10 mass %.

17. The inkjet recording medium of claim 16, wherein the content of the polyvinyl alcohol (B2) having a saponification degree of less than 90% in the lower ink receiving layer is within a range of 6 to 8 mass %.
